(19) United States
(12) Patent Application Publication
(10) Pub. No.: US 2016/0357095 A1
(43) Pub. Date: Dec. 8, 2016

(54) DISPLAY APPARATUS

(71) Applicant: OLYMPUS CORPORATION, Tokyo (JP)

(72) Inventors: Kanto MIYAZAKI, Tokyo (JP); Satoshi WATANABE, Tokyo (JP)

(73) Assignee: OLYMPUS CORPORATION, Tokyo (JP)

(21) Appl. No.: 15/242,351

(22) Filed: Aug. 19, 2016

Related U.S. Application Data
(63) Continuation of application No. PCT/JP2015/000827, filed on Feb. 20, 2015.

(30) Foreign Application Priority Data
Mar. 12, 2014 (JP) 2014-048787

(51) Int. Cl. G03B 21/14; G02B 27/00

(52) U.S. Cl. CPC G03B 21/145; G02B 27/0081; G02B 6/12004

(57) ABSTRACT

A display apparatus includes a light guide, an optical system that introduces image light into the light guide, a light beam extractor that emits the image light propagating in the light guide from a surface of the light guide along an extent of propagation of the image light, and a positioning member that positions a portion of the optical system by being in contact with the surface of the light guide.

### CROSS-REFERENCE TO RELATED APPLICATION

The present application is a Continuing Application based on International Application PCT/JP2015/000827 filed on Feb. 20, 2015, which in turn claims priority to Japanese Patent Application No. 2014-048787 filed on Mar. 12, 2014, the entire disclosure of these earlier applications being incorporated herein by reference.

### TECHNICAL FIELD

This disclosure relates to a display apparatus that displays an image by enlarging an exit pupil.

### BACKGROUND

In order, for example, to allow an observer to observe images at a variety of positions, one known display apparatus enlarges the exit pupil of an optical projection system (for example, see JP 2013-061480 A (PTL 1)). The display apparatus disclosed in PTL 1 introduces, into a light guide, image light to be displayed and guides the image light while repeatedly subjecting the image light to total reflection within the light guide. Total reflection refers to the phenomenon by which, when light enters a medium with a smaller refractive index from a medium with a larger refractive index, the incident light does not pass through the interface but rather is completely reflected. While the image light is being guided in the light guide, the image light is sequentially emitted from the surface of the light guide by a light beam extractor joined to the light guide. As a result, image light is emitted from nearly the entire surface of the light guide, the exit pupil of image light incident on the light guide is expanded, and an image can be observed as a virtual image at any position on the surface of the light guide.

### CITATION LIST

### Patent Literature

PTL 1: JP 2013-061480 A

### SUMMARY

A display apparatus according to this disclosure comprises:

a light guide;

an optical system configured to introduce image light into the light guide;

a light beam extractor configured to emit the image light propagating in the light guide from a surface of the light guide along an extent of propagation of the image light; and

a positioning member configured to position the light guide or a. portion of the optical system by being in contact with the surface of the light guide.

The positioning member may be in contact with the surface of the light guide by being pressed elastically against the surface of the light guide.

The positioning member may be in point contact with the surface of the light guide.

The positioning member may be in line contact with the surface of the light guide.

A surface of the positioning member in contact with the surface of the light guide may be a rough surface.

The rough surface may have a surface roughness Rv of 0.6 μm or greater.

The positioning member may be made of metal.

The positioning member may be made of plastic.

### BRIEF DESCRIPTION OF THE DRAWINGS

In the accompanying drawings:

FIG. 1 is a perspective view of a display apparatus according to Embodiment 1;

FIG. 2A schematically illustrates the structure of the optical image projection system in FIG. 1 as seen from the y-direction;

FIG. 2B schematically illustrates the structure of the optical image projection system in FIG. 2A as seen from the x-direction;

FIG. 3 is a perspective view displaying the structural components of the pupil enlarging optical system in FIG. 1 separated from each other;

FIG. 4 is a perspective view displaying the structural components of the first optical propagation system in FIG. 3 separated from each other;

FIG. 5 is a side view of the first optical propagation system;

FIG. 6 is a graph illustrating the reflectance versus the wavelength of a thin film, in order to illustrate the property of the spectral curve of the thin film shifting along the wavelength direction depending on the angle of incidence;

FIG. 7 is a graph illustrating the transmittance as a function of distance from an area of incidence on a first polarizing beam splitter film;

FIG. 8 is a perspective view displaying the structural components of the second optical propagation system in FIG. 3 separated from each other;

FIG. 9 illustrates a support mechanism of the half-wavelength plate of FIG. 3;

FIG. 10A is an example of a spacer as viewed from the y-direction;

FIG. 10B is an example of the spacer in FIG. 10A as viewed from the x-direction;

FIG. 11A is another example of a spacer as viewed from the y-direction;

FIG. 11B is an example of the spacer in FIG. 11A as viewed from the x-direction;

FIG. 12A is yet another example of a spacer as viewed from the y-direction;

FIG. 12B is an example of the spacer in FIG. 12A as viewed from the x-direction;

FIG. 13A illustrates the main structure of a display apparatus according to Embodiment 2;

FIG. 13B is a cross-section along the A-A line in FIG. 13A;

FIG. 14A illustrates an example of the receiving portion in FIG. 13A;

FIG. 14B illustrates another example of the receiving portion;

FIG. 14C illustrates yet another example of the receiving portion;

FIG. 15 schematically illustrates the main structure of a display apparatus according to Embodiment 3;

FIG. 16A illustrates a support mechanism of the optical propagation system of Embodiment 3;

FIG. 16B is a cross-section along the B-B line in FIG. 16A; and

FIG. 17 schematically illustrates the main structure of a display apparatus according to Embodiment 4.

### DETAILED DESCRIPTION

The following describes embodiments with reference to the drawings.

### Embodiment 1

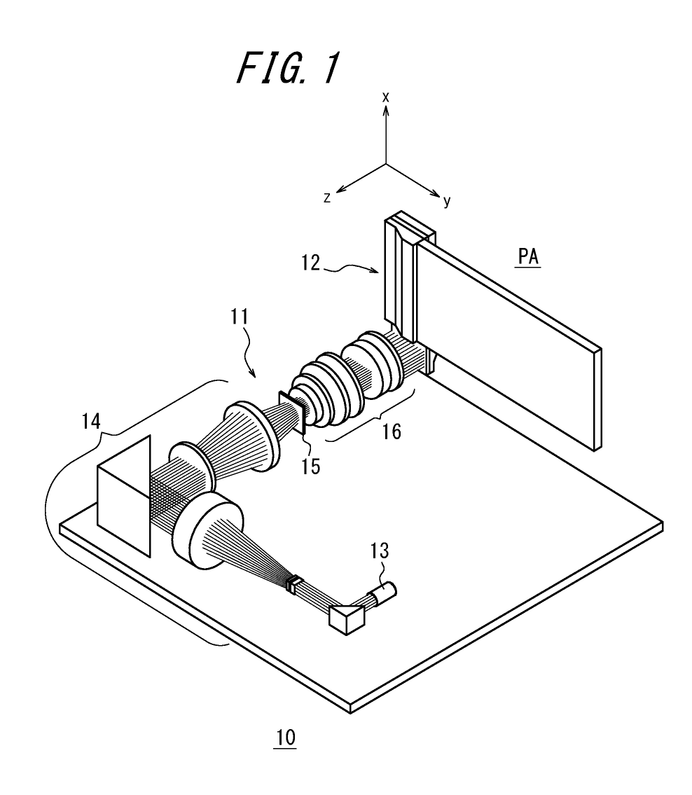

FIG. 1 is a perspective view of a display apparatus according to Embodiment 1. The display apparatus 10 illustrated in FIG. 1 includes an optical image projection system 11 and a pupil enlarging optical system 12. In this embodiment, the direction along the optical axis of the optical image projection system 11 is treated as the z-direction, and the directions that are perpendicular to the z-direction and perpendicular to each other are treated as the x-direction and the y-direction. In FIG. 1, the upward direction is the x-direction. Furthermore, near the pupil enlarging optical system 12 in FIG. 1, the direction diagonally downward to the right is the y-direction, and the direction diagonally downward to the left is the z-direction.

The optical image projection system 11 projects image light corresponding to an image to infinity. The image light projected by the optical image projection system 11 enters the pupil enlarging optical system 12, which enlarges the exit pupil and emits the result. By aligning the eye with any position in a projection area PA of the enlarged exit pupil, the observer can observe an image.

Next, the structure of the optical image projection system 11 is described. The optical image projection system 11 includes a light source 13, an optical illumination system 14, a transmissive chart 15, and an optical projection system 16. The light source 13 is driven by a light source driver (not illustrated) and emits a laser as illumination light using power supplied by a battery (not illustrated). The wavelength of the laser is in the visible light region and may, for example, be 532 nm.

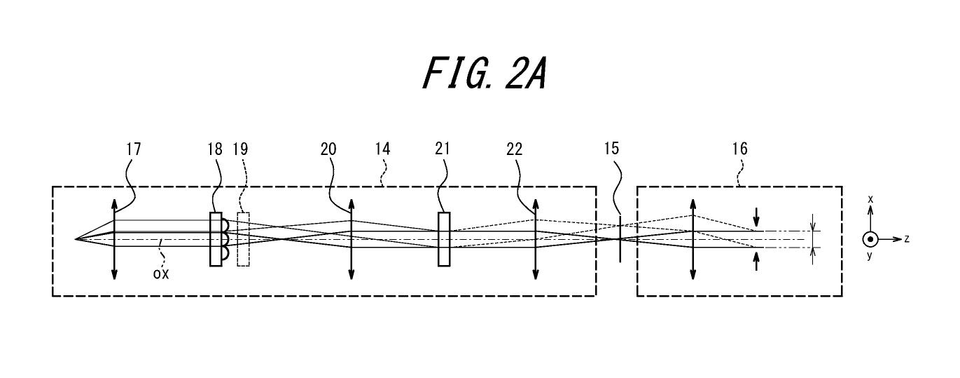

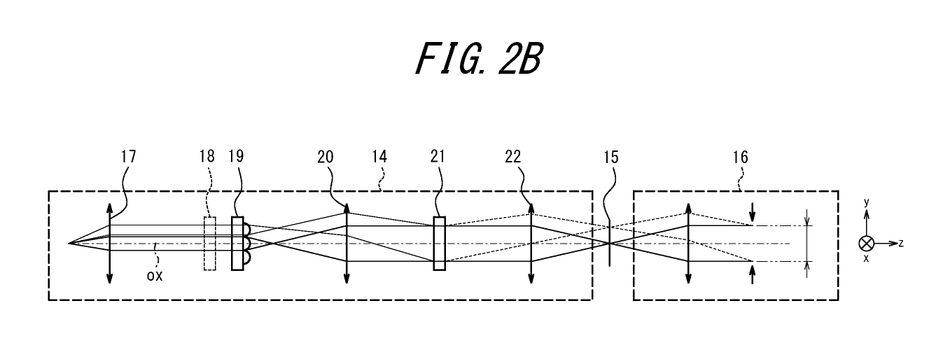

As illustrated in FIGS. 2A and 2B, the optical illumination system 14 includes a collimator lens 17, a first lenticular lens 18, a second lenticular lens 19, a first lens 20, a diffuser panel 21, and a second lens 22. The collimator lens 17, first lenticular lens 18, second lenticular lens 19, first lens 20, diffuser panel 21, and second lens 22 are optically joined. The collimator lens 17 converts the illumination light emitted from the light source 13 into parallel light.

The first lenticular lens 18 includes a plurality of lens elements with a shorter lens pitch than the width of the light beam of the illumination light exiting from the collimator lens 17, for example 0.1 mm to 0.5 mm, and is configured so that the entering parallel light beam extends across a plurality of lens elements. The first lenticular lens 18 has a refractive power in the x-direction and diffuses illumination light converted to a parallel light beam along the x-direction.

The second lenticular lens 19 has a shorter focal length than does the first lenticular lens 18. The focal lengths of the first lenticular lens 18 and of the second lenticular lens 19 may, for example, respectively be 1.6 mm and 0.8 mm. The second lenticular lens 19 is disposed so that the back focal positions of the first lenticular lens 18 and the second lenticular lens 19 substantially match. The second lenticular lens 19 includes a plurality of lens elements with a shorter lens pitch than the width of the light beam of the illumination light from the collimator lens 17, for example 0.1 mm to 0.5 mm, and is configured so that the entering parallel light beam extends across a plurality of lens elements. The second lenticular lens 19 has a refractive power in the y-direction and diffuses illumination light that was diffused in x-direction along the y-direction. A lenticular lens with an angle of diffusion in the y-direction larger than the angle of diffusion in the x-direction of the first lenticular lens 18 is used as the second lenticular lens 19.

The first lens 20 is disposed so that the front focal position of the first lens 20 substantially matches the back focal positions of the first lenticular lens 18 and the second lenticular lens 19. The focal length of the first lens 20 may, for example, be 50 mm. Accordingly, the first lens 20 converts illumination light components emitted from the plurality of lenses of the second lenticular lens 19 into parallel light beams with different exit angles and emits the parallel light beams.

The diffuser panel 21 is disposed to match the back focal position of the first lens 20 substantially. Accordingly, the plurality of parallel light beams emitted from the first lens 20 irradiate the diffuser panel 21 in a convoluted state. As a result, a laser that has a Gaussian intensity distribution irradiates the diffuser panel 21 as illumination light that has an approximately uniform intensity distribution and is rectangular, with a wider light beam width in the y-direction than in the x-direction. The diffuser panel 21 is driven by a diffusion panel driving mechanism (not illustrated), vibrates in a plane perpendicular to the optical axis OX, and reduces the visibility of speckles. The diffuser panel 21 may, for example, be a holographic diffuser designed to have a rectangular diffusion angle and irradiates the entire area of the below-described rectangular transmissive chart 15, with a uniform intensity and without excess or deficiency, with illumination light emitted from the diffuser panel 21.

The second lens 22 is disposed so that the front focal position of the second lens 22 substantially matches the position of the diffuser panel 21. The focal length of the second lens 22 may, for example, be 26 mm. The second lens 22 focuses, at each angle, the illumination light that is incident at a variety of angles.

The transmissive chart 15 constitutes a spatial light modulator and is disposed at the back focal position of the second lens 22. The transmissive chart 15 may, for example, be a rectangle with a length of 4.5 mm in the x-direction and a length of 5.6 mm in the y-direction. The transmissive chart 15 is driven by a chart driver (not illustrated) and forms any image to be displayed by the display apparatus 10. The pixels constituting the image of the transmissive chart 15 are irradiated by the parallel light beams focused at respective angles. Accordingly, the light passing through the pixels constitutes image light.

The optical projection system 16 is disposed so that the exit pupil of optical projection system 16 and the diffuser panel 21 are optically conjugate. Accordingly, the exit pupil has a rectangular shape that is longer in the y-direction than in the x-direction. The focal length of the optical projection system 16 is, for example, 28 mm, and the image light projected through the transmissive chart 15 is projected to infinity. As image light, the optical projection system 16 emits a group of parallel light beams having angular components in the x-direction and the y-direction corresponding to the position in the x-direction and the y-direction of the pixels of the transmissive chart 15, i.e. the object height from the optical axis OX. In this embodiment, for example the light beams exit in an angular range of ±4.6° in the x-direction and ±5.7° in the y-direction. The image light projected by the optical projection system 16 enters the pupil enlarging optical system 12.

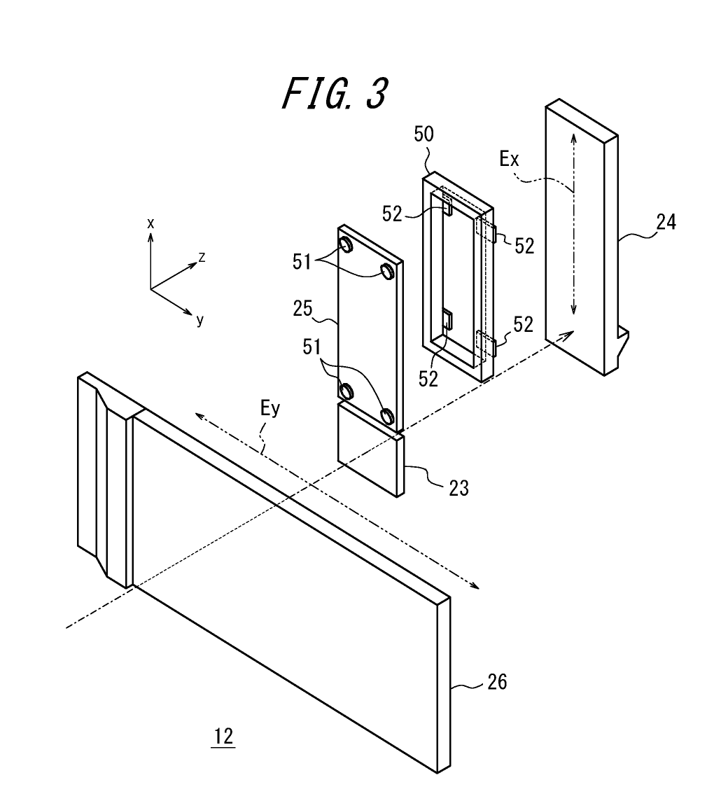

Next, the structure of the pupil enlarging optical system 12 is described with reference to FIG. 3. The pupil enlarging optical system 12 includes a polarizer 23, a first optical propagation system 24, a half-wavelength plate 25, and a second optical propagation system 26. In FIG. 3, for the sake of illustration, the polarizer 23, first optical propagation system 24, half-wavelength plate 25, and second optical propagation system 26 are displayed as being widely separated, but these components are actually arranged in close proximity, as illustrated in FIG. 1.

The polarizer 23 is disposed between the exit pupil of the optical projection system 16 and the first optical propagation system 24. Image light from the optical projection system 16 is incident on the polarizer 23, which emits s-polarized light. The first optical propagation system 24 is disposed so that the area of incidence (not illustrated in FIG. 3) of a second planar surface (not illustrated in FIG. 3) of the below-described first light guide (not illustrated in FIG. 3) and the exit pupil of the optical projection system 16 are combined. The first optical propagation system 24 enlarges, in the x-direction, the exit pupil projected as s-polarized light by the polarizer 23 and emits the result (see reference sign “Ex”). The half-wavelength plate 25 rotates, by 90°, the polarization plane of the image light expanded in the x-direction. By rotating the polarization plane 90°, the image light can be caused to enter the first polarizing beam splitter film (not illustrated in FIG. 3) of the second optical propagation system 26 as s-polarized light. The second optical propagation system 26 expands the image light, the polarization plane of which was rotated by the half-wavelength plate 25, in the y-direction and emits the result (see reference sign “Ey”).

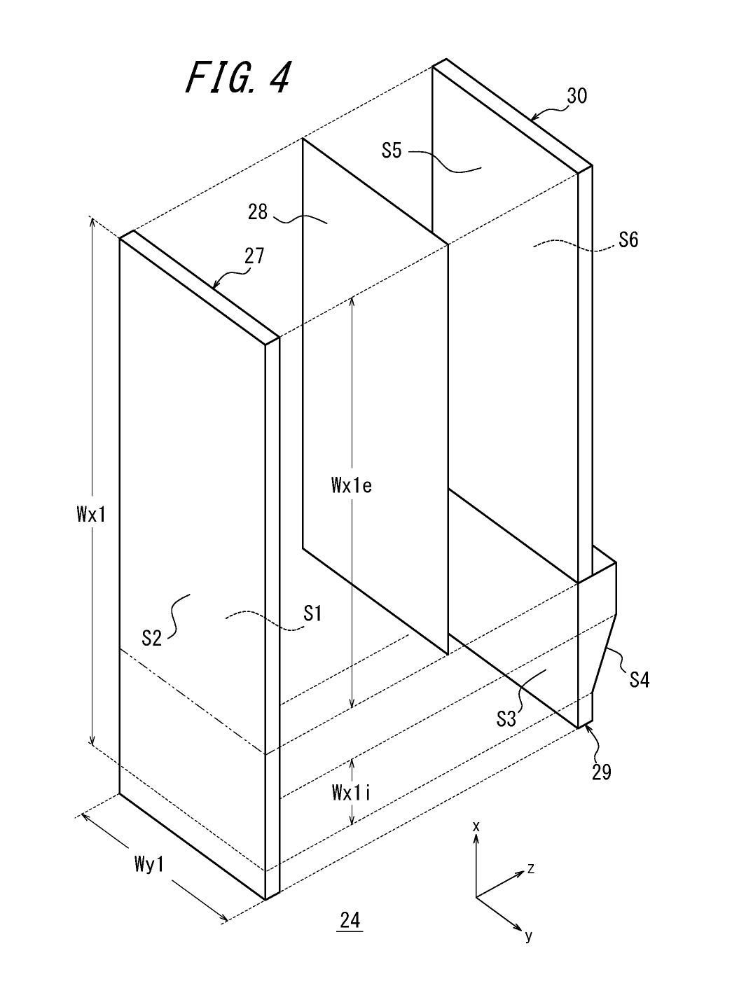

Next, the function by which the first optical propagation system 24 expands the exit pupil is described along with the structure of the first optical propagation system 24. As illustrated in FIG. 4, the first optical propagation system 24 includes a first light guide 27, a first polarizing beam splitter film 28, a first input deflector 29, and a first output deflector 30. The first polarizing beam splitter film 28 is vapor deposited on the first light guide 27, as described below, and cannot be separated from the first light guide 27, but these components are illustrated schematically in FIG. 4 as being separated.

The first light guide 27 is a flat plate with transmittivity having a first planar surface S1 and a second planar surface S2 that are parallel and oppose each other. The first input deflector 29 is a prism that has a planar input side bonded surface S3 and an inclined surface S4 that is inclined relative to the input side bonded surface S3. The first output deflector 30 is a plate-shaped member with transmittivity having an output side bonded surface S5, and on the back side, a triangular prism array surface S6 on which a triangular prism array is formed.

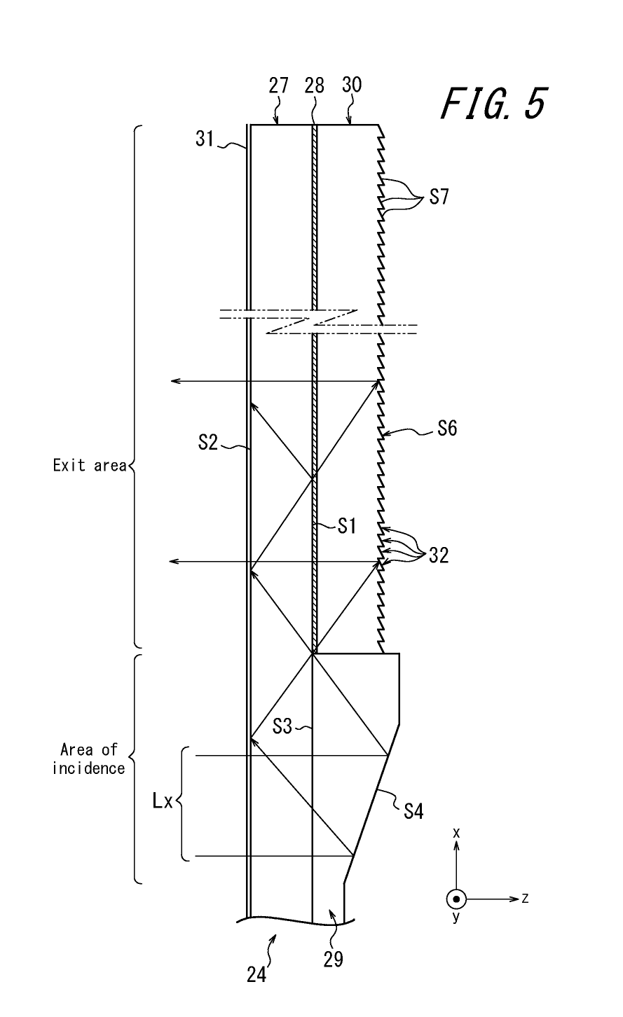

In a partial area of the first planar surface S1 of the first light guide 27, the first polarizing beam splitter film 28 is formed by vapor deposition to have substantially the same size as the output side bonded surface S5 of the first output deflector 30. The first output deflector 30 is bonded at the output side bonded surface S5 by transparent adhesive to the area of the first planar surface S1 in which the first polarizing beam splitter film 28 is formed. The first input deflector 29 is bonded at the input side bonded surface S3 by transparent adhesive to the area of the first planar surface S1 other than the area in which the first polarizing beam splitter film 28 is formed. The first optical propagation system 24 is integrated by the first light guide 27 being bonded to the first output deflector 30 and the first input deflector 29. Hereinafter, in the longitudinal direction of the first optical propagation system 24 (the “x-direction” in FIG. 4), the area in which the first input deflector 29 is provided is referred to as the area of incidence, and the area in which the first output deflector 30 is provided is referred to as the exit area (see FIG. 5). As described below, the first polarizing beam splitter film 28 is preferably formed so as to enter slightly into the area of incidence.

The integrated first optical propagation system 24 is a flat plate, and the lengths Wx1 and Wy1 respectively in the length direction (the “x-direction” in FIG. 4) and the width direction (the “y-direction” in FIG. 4) of the first optical propagation system 24 and the first light guide 27 may, for example, be 60 mm and 20 mm. The length Wx1e of the first polarizing beam splitter film 28 in the longitudinal direction may, for example, be 50 mm. The length Wx1i of the first input deflector 29 in the longitudinal direction may, for example, be 7 mm. As illustrated in FIG. 4, the first input deflector 29 may include a section with a surface other than the inclined surface S4 as a surface that faces the input side bonded surface S3, but the length Wx1i of the first input deflector 29 in the longitudinal direction is the length of the inclined surface S4 in the longitudinal direction.

The first polarizing beam splitter film 28 is a multilayer film designed to transmit light that enters from a substantially perpendicular direction while reflecting the majority and transmitting the remainder of light that enters obliquely. Such properties may be obtained by a thin film with low-pass or band-pass type spectral reflectance.

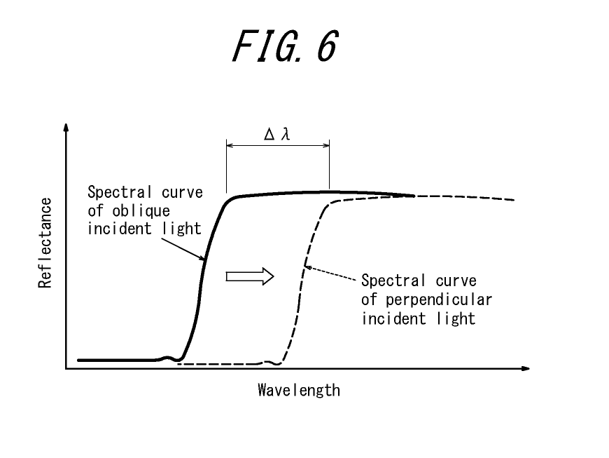

As is known, the spectral curve shifts in the wavelength direction in accordance with the angle of incidence on a thin film. As illustrated in FIG. 6, the spectral curve (see the dashed line) with respect to approximately perpendicular incident light shifts in the longer wavelength direction from the spectral curve with respect to oblique incident light (see the solid line). The first polarizing beam splitter film 28 can be formed by combining the wavelength of the incident light beam Lx and the settings of the thin film so as to be sandwiched between the cutoff wavelengths of the spectral curve with respect to oblique incident light and the spectral curve with respect to approximately perpendicular incident light and so that the reflectance with respect to oblique incident light is 95% and the reflectance with respect to approximately perpendicular incident light is 0%.

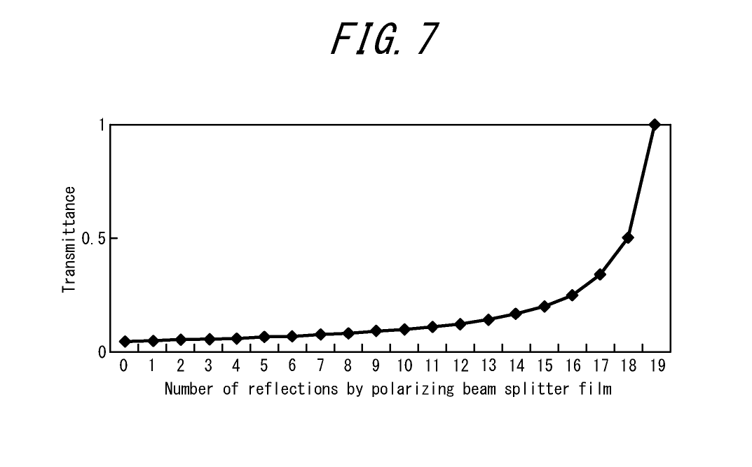

The first polarizing beam splitter film 28 has transmittance, with respect to oblique incident light, that changes in accordance with position along the x-direction. For example, the first polarizing beam splitter film 28 is formed so that the transmittance increases as a geometric progression (see FIG. 7) in accordance with distance from one end of the first polarizing beam splitter film 28 at the first input deflector 29 side. Such a film may be formed by vapor deposition by, for example, designing the process in advance so that the distance from the vapor deposition source changes in accordance with planar distance from the first input deflector 29, so as to yield desired reflectance properties at each position in accordance with the difference in distance (difference in thickness of the film that is formed).

Synthetic quartz (a transparent medium) for example having a thickness, i.e. a length in the z-direction, of 2 mm may be used as the first light guide 27 (see FIG. 4). Using synthetic quartz is advantageous in that the first light guide 27 has heat resistance with respect to heating when the first polarizing beam splitter film 28 is vapor deposited and does not warp easily under film stress, since synthetic quartz is a hard material.

An antireflection (AR) film 31 is formed on the second planar surface S2 of the first light guide 27. The AR film 31 suppresses reflectance of image light entering from the perpendicular direction. The AR film 31 is designed and formed so that the film stress thereof matches the film stress of the first polarizing beam splitter film 28. By causing the film stress to match, warping of the first optical propagation system 24 can be suppressed, contributing to good propagation of image light.

The first input deflector 29 is, for example, formed from synthetic quartz. By forming the first input deflector 29 from synthetic quartz, i.e. the same material as the first light guide 27, the reflectance at the interface between the input side bonded surface S3 and the first planar surface S1 can be reduced ideally.

Aluminum is vapor deposited on the inclined surface S4 of the first input deflector 29 and functions as a reflecting film. As illustrated in FIG. 5, a normal line to the inclined surface S4 extends to the exit area side of the first light guide 27. Accordingly, a light beam incident perpendicularly on the second planar surface S2 of the first light guide 27 in the area of incidence is reflected by the inclined surface S4 inside the first input deflector 29 and propagates towards the exit area. The apex angle between the input side bonded surface S3 and the inclined surface S4 is described below. The interface between the first input deflector 29 and the first output deflector 30 is colored black and absorbs the incident light beam without reflecting the light beam.

The first output deflector 30 is, for example, formed by acrylic having a thickness of 3 mm. The triangular prism array formed on the first output deflector 30 is minute and is formed by mold injection. Acrylic, which can be formed by mold injection and is a transparent medium, has thus been selected as an example. Aluminum is vapor deposited on the triangular prism array surface S6 and functions as a reflecting film. The first output deflector 30 is formed by acrylic in this embodiment but is not limited to being acrylic resin. However, when the first output deflector 30 is joined on a planar surface with a film having properties in one polarization direction, like the first polarizing beam splitter film 28, the material and formation conditions are preferably selected to allow suppression of occurrence of birefringence within the material.

On the triangular prism array surface S6 of the first output deflector 30, a plurality of triangular prisms 32 extending in the y-direction are formed. The triangular prisms 32 are aligned in the x-direction in saw-toothed fashion with a pitch of, for example, 0.9 mm.

The inclination angle of an inclined surface S7 of each triangular prism 32 relative to the output side bonded surface S5 is opposite from the inclination of the inclined surface S4 of the first input deflector 29, i.e. a normal line to the inclined surface S7 extends to the area of incidence side of first light guide 27. The absolute value of the inclination angle of each triangular prism 32 is substantially equal to the inclination angle of the inclined surface S4 or differs over a range of a few degrees in accordance with the combination of materials used for the first input deflector 29, the first light guide 27, and the first output deflector 30. The difference in angle between adjacent prisms on the triangular prism array surface S6 is approximately 0.01° (0.5 min) or less.

The apex angle between the input side bonded surface S3 and the inclined surface S4 of the first input deflector 29 and the inclination angle of triangular prisms 32 is determined based on the critical angle at the second planar surface S2 of the first light guide 27, as described below.

The first optical propagation system 24 is disposed so that a light beam Lx parallel to the optical axis OX of the optical image projection system 11 is incident from the outside perpendicularly on the area of incidence at the second planar surface S2. The light beam Lx incident perpendicularly on the area of incidence enters the first input deflector 29 from the first light guide 27 and is reflected diagonally by the inclined surface S4. The diagonally reflected light beam Lx passes through the inside of the first light guide 27 and is incident on the second planar surface S2. The apex angle between the input side bonded surface S3 and the inclined surface S4 of the first input deflector 29 and the inclination angle of the triangular prism 32 are determined so that the light beam Lx incident on the second planar surface S2 in the first light guide 27 is totally reflected.

Accordingly, the angle of incidence θ relative to the second planar surface S2 in the first light guide 27 needs to exceed the critical angle, i.e. the relationship θ>critical angle=sin⁻¹ (1/n) (where n is the refractive index of the first light guide 27) needs to hold. In this embodiment, the first light guide 27 is formed from synthetic quartz as described above, and therefore the critical angle is 43.6°.

With regard to the light beam at the object height that is incident perpendicularly from the optical image projection system 11, the angle of incidence θ on the second planar surface S2 inside the first light guide 27 is twice the inclination angle of the inclined surface S4 relative to the input side bonded surface S3 of the first input deflector 29. Hence, the inclination angle needs to be at least 21.8°. In this embodiment, the inclination angle is 25.8°, for example, which is at least 21.8°. The inclination angle of each triangular prism 32 is, for example, 25°.

Based on the size of the transmissive chart 15 and the focal length of the optical projection system 16, the angle of the light ray incident on the area of incidence of the second planar surface S2 can be restricted. For example, the angle of the incident light ray can be restricted to be within a range of ±4.6° in the x-direction and ±5.7° in the y-direction on the air side and within a range of ±3.1° in the x-direction and ±3.9° in the y-direction in the medium of the first light guide 27 formed from synthetic quartz. With such an angle restriction, the light beam at the angle of image light corresponding to all object heights can be totally reflected at the second planar surface S2 within the first light guide 27 in the above-described first optical propagation system 24.

In the first optical propagation system 24 structured and arranged as described above, the light beam Lx incident perpendicularly on the area of incidence of the second planar surface S2 is reflected at the inclined surface S4 of the first input deflector 29 and is incident diagonally on the exit area of the second planar surface S2 inside the first light guide 27. A light beam Lx incident diagonally is incident on the second planar surface S2 at an angle exceeding the critical angle and is totally reflected. In other words, by being incident from a medium with a larger refractive index to a medium with a smaller refractive index at an angle of incidence exceeding the critical angle, light beam Lx does not pass through the second planar surface S2 at the interface, but rather is totally reflected. The totally reflected light beam Lx is incident diagonally on the first polarizing beam splitter film 28. Only a predetermined percentage of light is transmitted, and the remainder of the light is reflected. The light beam Lx reflected at the first polarizing beam splitter film 28 is incident again on the second planar surface S2 at an angle exceeding the critical angle and is totally reflected. Subsequently, the light beam Lx propagates in the x-direction of the first light guide 27 while repeatedly being partially reflected at the first polarizing beam splitter film 28 and totally reflected at the second planar surface S2. Each time the light beam Lx is incident on the first polarizing beam splitter film 28, however, a predetermined percentage of the light beam Lx is transmitted and is incident on the first output deflector 30.

The light beam Lx incident on the first output deflector 30 is once again deflected by the reflecting film on the inclined surface S7 of the triangular prism 32 in a direction perpendicular to the second planar surface S2 of the first light guide 27. The light beam Lx deflected in the perpendicular direction passes through the first polarizing beam splitter film 28 at a transmittance of substantially 100% and exits to the outside from the second planar surface S2. Accordingly, in the first optical propagation system 24, the light beam extractor is configured to include the first polarizing beam splitter film 28 and the first output deflector 30.

The half-wavelength plate 25 (see FIG. 3) is formed into a shape substantially the same size as the exit area of the second planar surface S2. The half-wavelength plate 25 is disposed at a position opposite the exit area of the second planar surface S2, with a gap therebetween. Accordingly, the light beam obliquely incident on the second planar surface S2 in the first light guide 27 does not pass through the second planar surface S2, but rather total reflection is guaranteed. As described above, the half-wavelength plate 25 rotates the polarization plane of the light beam emitted from the first optical propagation system 24 by 90°. The support mechanism of the half-wavelength plate 25 is described below in detail.

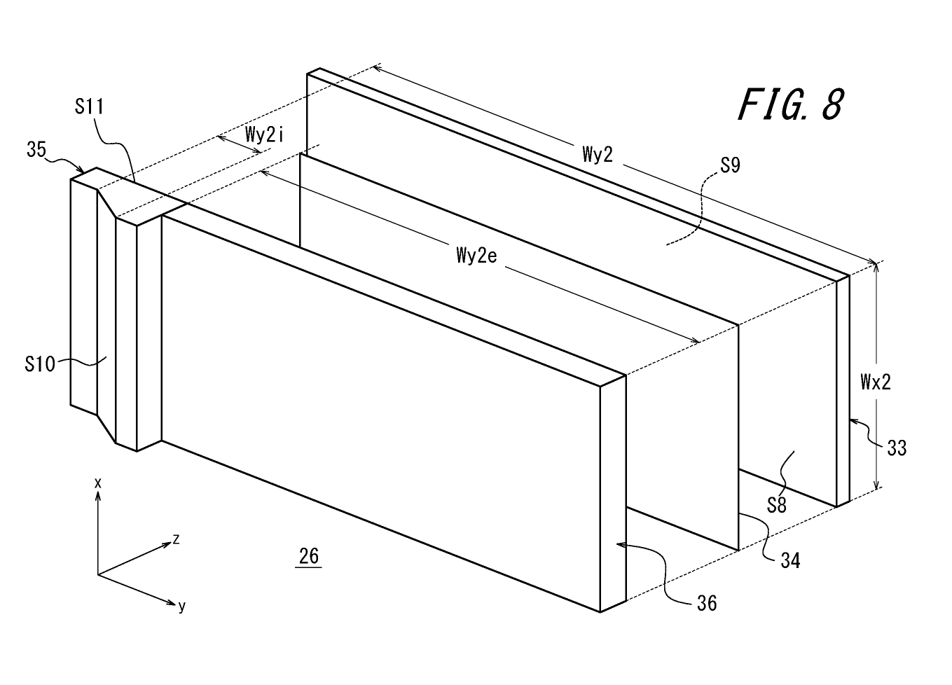

The structure of the second optical propagation system 26 other than the size and the arrangement thereof is the same as that of the first optical propagation system 24. As illustrated in FIG. 8, the second optical propagation system 26 includes a second light guide 33, a second polarizing beam splitter film 34, a second input deflector 35, and a second output deflector 36. Like the first optical propagation system 24, these constituent members are in the shape of an integrated flat plate, and the lengths Wx2 and Wy2 respectively in width direction (the “x-direction” in FIG. 8) and the length direction (the “y-direction” in FIG. 8) of the second optical propagation system 26 and the second light guide 33 may, for example, be 50 mm and 110 mm. The length Wy2e of the second polarizing beam splitter film 34 in the longitudinal direction in the second optical propagation system 26 may, for example, be 100 mm. The length Wy2i of the second input deflector 35 in the longitudinal direction may, for example, be 10 mm. The second light guide 33, second polarizing beam splitter film 34, second input deflector 35, and second output deflector 36 are respectively similar in function to the first light guide 27, first polarizing beam splitter film 28, first input deflector 29, and first output deflector 30.

The second light guide 33 includes a third planar surface S8, on which the second polarizing beam splitter film 34 is vapor deposited, and a fourth planar surface S9 opposing the third planar surface S8. The fourth planar surface S9 is the observer-side surface. The second optical propagation system 26 is disposed so that the exit area of the second planar surface S2 of the first optical propagation system 24 and the area of incidence of the fourth planar surface S9 of the second optical propagation system 26 face each other, and so that the second optical propagation system 26 is rotated 90° with respect to the first optical propagation system 24 about an axis that is a line parallel to the z-direction (see FIG. 3). Accordingly, in the second optical propagation system 26, the light beam extractor is configured to include the second polarizing beam splitter film 34 and the second output deflector 36. The second optical propagation system 26 enlarges, in the y-direction, the exit pupil of the image light emitted from the first optical propagation system 24 and emits the image light from the projection area PA of the fourth planar surface S9, which is the observer-side surface of the second light guide 33.

In the first optical propagation system 24, the AR film 31 on the second planar surface S2 of the first light guide 27 may be omitted. Similarly, in the second optical propagation system 26, the AR film on the fourth planar surface S9 of the second light guide 33 may be omitted.

The above-described optical image projection system 11 is fixed to a fixing portion of the display apparatus 10. In the pupil enlarging optical system 12, the polarizer 23, first optical propagation system 24, and second optical propagation system 26 are fixed to the fixing portion of the display apparatus 10 so as to allow observation, from the outside, of the projection area PA. In this embodiment, the half-wavelength plate 25 that is a part of the optical system that introduces image light into the second light guide 33 of the second optical propagation system 26 is positioned by a positioning member that contacts the fourth planar surface S9, which is the surface of the second light guide 33. The half-wavelength plate 25 is thus supported on the fourth planar surface S9. The following describes the support mechanism of the half-wavelength plate 25.

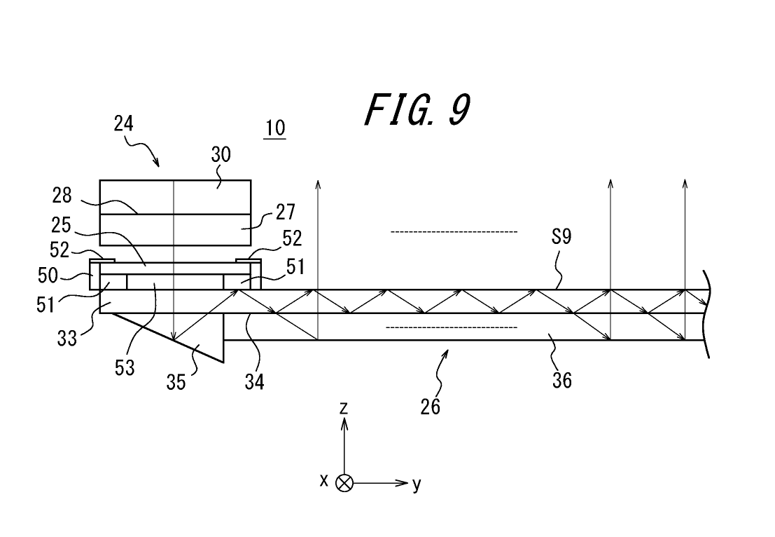

As illustrated in FIGS. 3 and 9, the half-wavelength plate 25 is supported by a frame-shaped support member 50. The support member 50 restricts displacement of the half-wavelength plate 25 in the x-direction and the y-direction and supports the half-wavelength plate 25 to be displaceable in the z-direction. The support member 50 is fixed to the fixing portion of the display apparatus 10. At the periphery of the exit surface of half-wavelength plate 25, i.e. the surface on the second light guide 33 side, spacers 51 are adhered to the half-wavelength plate 25 at a plurality of locations (the four corners in FIG. 3) in a region through which image light does not pass. The spacers 51 each constitute a positioning member.

On the support member 50, elastic members 52 for example formed by leaf springs are provided at a plurality of locations (the four corners in FIG. 3) on the surface of the support member 50 at the first light guide 27 side. The elastic members 52 are provided so as to push the periphery of the half-wavelength plate 25, through which image light from the entrance surface does not pass, towards the second light guide 33. The elastic members 52 elastically press the spacers 51 into contact with the fourth planar surface S9 of the second light guide 33. As a result, the half-wavelength plate 25 is positioned on the fourth planar surface S9 and is disposed facing the fourth planar surface S9 with a gap 53, formed by the spacers 51, therebetween.

The support member 50 is not limited to being frame-shaped. It suffices for the support member 50 to be able to position the half-wavelength plate 25 in the x-direction and the y-direction and to support the half-wavelength plate 25 to be displaceable in the z-direction. Accordingly, the support member 50 may for example be configured to include four corner members with an L-shaped xy cross-section that contact the corners of the half-wavelength plate 25 or may be configured to include at least four protruding members that contact the four sides of the half-wavelength plate 25. Furthermore, the spacers 51 are not limited to being at the four corners of the half-wavelength plate 25. It suffices to provide three or more spacers 51 in a region through which image light does not pass so that the half-wavelength plate 25 is disposed facing the fourth planar surface S9 with the gap 53 therebetween.

For example, the spacers 51 are in the shape of a cylinder with a diameter of approximately 1 mm, are approximately 0.5 mm thick (dimension in the z-direction), and are made of a metal such as brass or a plastic such as polyacetal. The spacers 51 are not limited to being cylindrical and may be any shape, such as a triangular or polygonal prism. The shape and thickness of the spacers 51 may also be set appropriately out of consideration for reduction in apparatus size, provided that the gap 53 that guarantees total reflection of image light within the second light guide 33 is formed without affecting the image light passing through the half-wavelength plate 25.

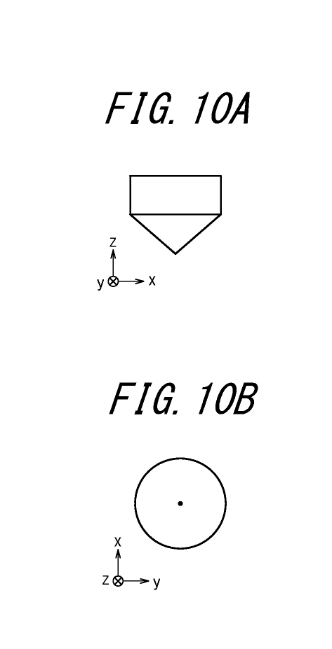

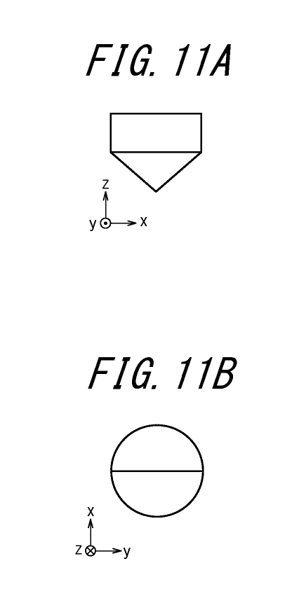

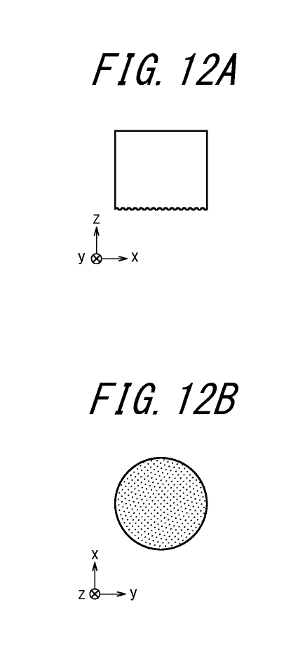

The spacers 51 are formed on the second light guide 33 side, for example as illustrated in FIGS. 10A and 10B, FIGS. 11A and 11B, or FIGS. 12A and 123. The spacer 51 illustrated in FIGS. 10A and 103 is formed to be conical at the second light guide 33 side so as to be in point contact with the fourth planar surface S9. The spacer 51 illustrated in FIGS. 11A and 11B is formed to be roof-shaped with one ridge line at the second light guide 33 side so as to be in line contact with the fourth planar surface S9. The spacer 51 illustrated in FIGS. 12A and 12B is formed to have a rough surface at the second light guide 33 side so as to be in point contact with the fourth planar surface S9 at a plurality of points. In FIGS. 10A, 11A, and 12A, the spacer 51 is viewed from the y-direction, whereas in FIGS. 10B, 11B, and 12B, the spacer 51 is viewed from the z-direction.

When the distance between the spacer 51 and the fourth planar surface S9 is equal to or greater than the wavelength of the image light, the image light propagating within the second light guide 33 is completely reflected without escaping at the fourth planar surface S9 as evanescent light. Conversely, when the distance between the spacer 51 and the fourth planar surface S9 is less than the wavelength of image light, the image light propagating within the second light guide 33 at that portion escapes from the fourth planar surface S9, thereby reducing the reflectance at the fourth planar surface S9. Therefore, when the spacer 51 has the structure in FIGS. 10A and 10B or the structure in FIGS. 11A and 11B, the apex of the spacer 51 at the second light guide 33 side is preferably made as small as possible while taking factors such as strength into consideration. When the spacer 51 has the structure in FIGS. 12A and 12B, the surface roughness of the spacer 51 at the second light guide 33 side, for example the maximum valley depth Rv of the roughness curve, is preferably 0.6 μm or greater, which is a depth that encompasses green wavelengths to which the human eye is highly sensitive. The maximum valley depth Rv is more preferably 0.7 μm or greater, which is a depth that encompasses the wavelengths of the visible light region.

In this way, by structuring the second light guide 33 side of the spacers 51 as illustrated in FIGS. 10A and 10B, FIGS. 11A and 11B, or FIGS. 12A and 12B for point contact or line contact with the fourth planar surface S9, the contact area between the spacers 51 and the fourth planar surface S9 can be made extremely small as compared to the area of a human pupil. Accordingly, even if a portion of the image light is absent at the contact portion between the spacers 51 and the fourth planar surface S9, there is nearly no effect on the image quality of the observed image. Furthermore, by positioning the half-wavelength plate 25 on the second light guide 33 via the spacers 51, the gap 53 equal to or greater than the wavelength of image light can be formed reliably between the half-wavelength plate 25 and the fourth planar surface S9, guaranteeing total reflection of image light in the second light guide 33, and an increase in size of the second light guide 33 can be avoided.

Therefore, according to this embodiment, a display apparatus that allows observation of an image with good image quality without increasing the size and cost of the apparatus can be achieved. Due to having a small contact area with respect to the fourth planar surface S9, the spacers 51 might deform upon being made of a soft material, causing the half-wavelength plate 25 to tilt. Therefore, the spacers 51 preferably have a Rockwell hardness of R100 or greater.

### Embodiment 2

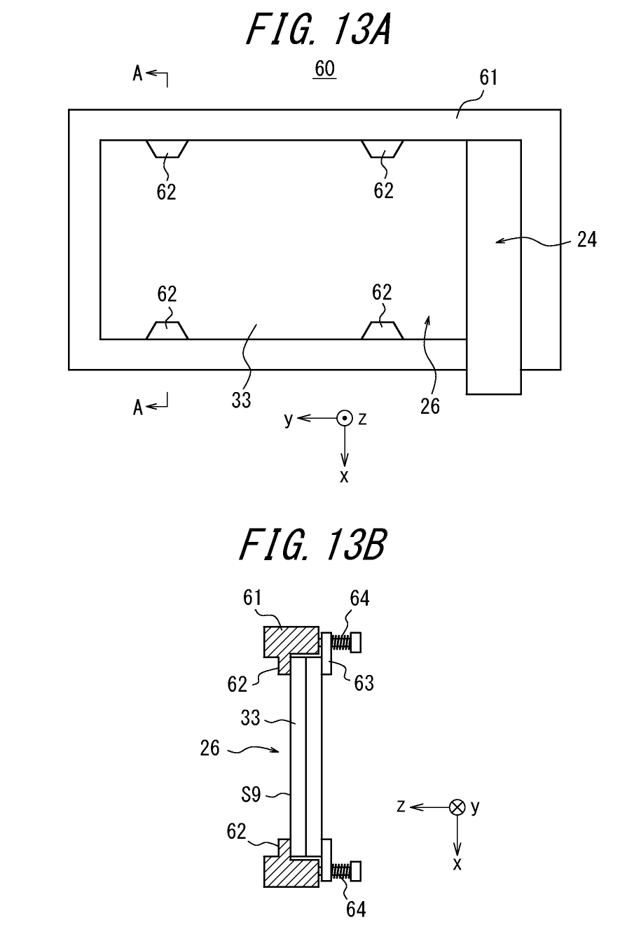

FIGS. 13A and 13B illustrate a display apparatus according to Embodiment 2, with FIG. 13A schematically illustrating the main structure of the display apparatus, and FIG. 13B illustrating a cross-section along the A-A line in FIG. 13A. In other words, FIG. 13A is a schematic view of FIG. 1 from the projection area PA side of the pupil enlarging optical system 12. A display apparatus 60 according to this embodiment has the structure of the display apparatus 10 of Embodiment 1, except that the support mechanism of the second optical propagation system 26 is configured differently. Portions identical to Embodiment 1 are labeled with the same reference signs, and a description thereof is omitted. The differences from Embodiment 1 are described below.

The second optical propagation system 26 is supported by a frame-shaped support member 61. The support member 61 restricts displacement of the second optical propagation system 26 in the x-direction and the y-direction and supports the second optical propagation system 26 to be displaceable in the z-direction. The support member 61 is fixed to the fixing portion of the display apparatus 60. A plurality of receiving portions 62 that project towards the inside of the frame are formed on the support member 61. The receiving portions 62 constitute a positioning member that positions the second light guide 33 by abutting against the periphery of the fourth planar surface S9 of the second light guide 33. FIGS. 13A and 13B illustrate examples in which the two sides of the support member 61 extending in the y-direction each have two receiving portions 62.

In FIG. 13A, at the back surface side of the support member 61, pressing members 63 that can each abut against the periphery of the second output deflector 36 at the triangular prism array surface thereof are provided at positions corresponding to the receiving portions 62. Each pressing member 63 is provided so as to be slidable in the z-direction and to be rotatable in the xy-plane for insertion into and removal from the open region in the frame of the support member 61. Each pressing member 63 is pressed towards the corresponding receiving portion 62 by an elastic member 64 that is a spring, a leaf spring, rubber, a sponge, or the like. FIG. 13B illustrates an example of the elastic member 64 being a spring.

With the pressing members 63 removed from the open region of the support member 61, the second optical propagation system 26 is inserted into the frame of the support member 61. Subsequently, the pressing members 63 are inserted into the open region of the support member 61 and pressed towards the receiving portion 62 by the elastic members 64. As a result, the fourth planar surface S9 of the second light guide 33 is elastically pressed into contact with the receiving portions 62 to position the second optical propagation system 26.

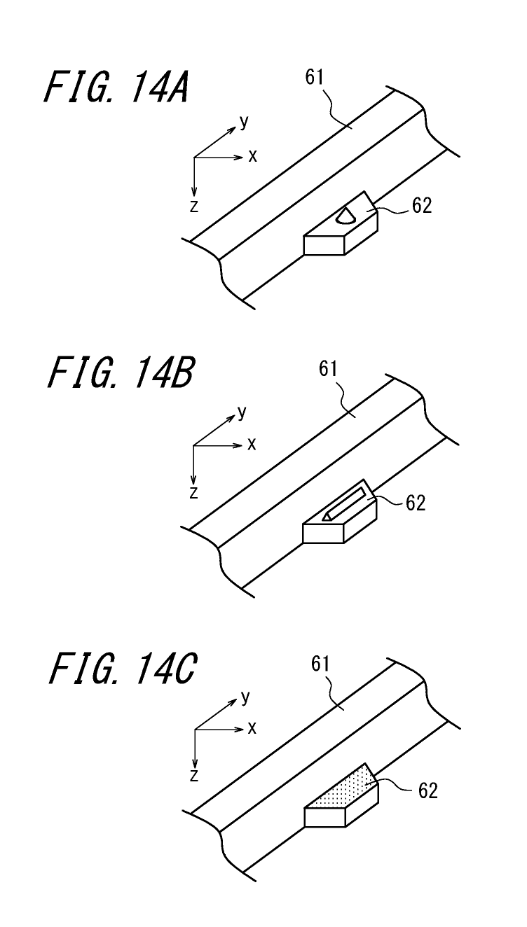

The side of the receiving portion 62 contacted by the fourth planar surface S9 of the second light guide 33 is formed as in FIGS. 10A and 10B, FIGS. 11A and 11B, or FIGS. 12A and 12B, as illustrated by the partial enlargement perspective views in FIGS. 14A, 14B, and 14C. In other words, the receiving portion 62 illustrated in FIG. 14A is formed to be conical at the second light guide 33 side so as to be in point contact with the fourth planar surface S9. The receiving portion 62 illustrated in FIG. 14B is formed to be roof-shaped with one ridge line at the second light guide 33 side so as to be in line contact with the fourth planar surface S9. The receiving portion 62 illustrated in FIG. 14C is formed to have a rough surface at the second light guide 33 side so as to be in point contact with the fourth planar surface S9 at a plurality of points. The surface roughness in the case of a rough surface, for example the maximum valley depth Rv of the roughness curve, is preferably 0.6 μm or greater, and more preferably 0.7 μm or greater, as in the case of FIGS. 12A and 12B.

In this way, by structuring the second light guide 33 side of the receiving portions 62 as illustrated in FIG. 14A, FIG. 14B, or FIG. 14C for point contact or line contact with the fourth planar surface S9, the contact area between the receiving portions 62 and the fourth planar surface S9 can be made extremely small as compared to the area of a human pupil. Accordingly, even if a portion of the image light is absent at the contact portion between the receiving portions 62 and the fourth planar surface S9, there is nearly no effect on the image quality of the observed image. Furthermore, by placing the receiving portions 62 in contact with the periphery of the second light guide 33 to position the second optical propagation system 26, an increase in size of the second light guide 33 can be avoided.

Therefore, according to this embodiment, a display apparatus that allows observation of an image with good image quality without increasing the size and cost of the apparatus can be achieved, as in Embodiment 1.

In this embodiment, the support member 61 is not limited to being frame-shaped. It suffices for the support member 61 to be able to position the second optical propagation system 26 in the x-direction and the y-direction and to support the second optical propagation system 26 to be displaceable in the z-direction. Accordingly, the support member 61 may for example be configured to include four corner members with an L-shaped xy cross-section that contact the corners of the second light guide 33 or may be configured to include at least four protruding members that contact the four sides of the second light guide 33. Any number of the receiving portions 62 may be formed along any of the sides, so long as displacement of the second optical propagation system 26 in the z-direction can be restricted. For example, in FIG. 13A, two receiving portions 62 may be formed on each of the two sides that extend in the x-direction instead of the two sides that extend in the y-direction. When the support member 61 is formed to include four corner members or four protruding members as described above, a receiving portion may be formed at each of the corner members or protruding members. The pressing members 63 do not necessarily need to be provided in correspondence with the receiving portions 62 and may be provided at any positions along the periphery of the second output deflector 36 at the triangular prism array surface thereof so that the second light guide 33 can be pressed into contact with the plurality of receiving portions 62 approximately uniformly.

### Embodiment 3

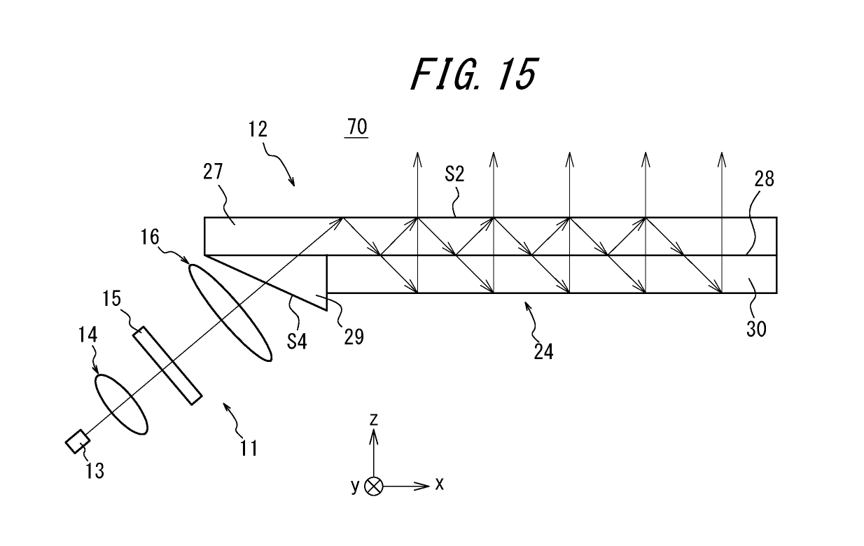

FIG. 15 schematically illustrates the structure of the overall optical system in a display apparatus according to Embodiment 3. A display apparatus 70 according to this embodiment has the same structure as the above-described embodiments, except that the pupil enlarging optical system 12 is constituted by the first optical propagation system 24, omitting the polarizer 23, the half-wavelength plate 25, and the second optical propagation system 26. Portions identical to the above-described embodiments are labeled with the same reference signs, and a detailed description thereof is omitted. The differences from the above-described embodiments are described below. In the following explanation, the first optical propagation system 24 is referred to simply as an optical propagation system 24. Similarly, constituent elements of the optical propagation system 24 are simply referred to as a light guide 27, polarizing beam splitter film 28, input deflector 29, and output deflector 30.

In the optical image projection system 11, image light from the outside is directly incident on the inclined surface S4 of the input deflector 29 in the optical propagation system 24. Accordingly, in this embodiment, a reflecting film is of course not formed on the inclined surface S4. The image light incident on the inclined surface S4 is incident on the second planar surface S2 in the light guide 27 at an angle exceeding the critical angle. The image light entering the light guide 27 is propagated in the x-direction while repeatedly undergoing total reflection in the light guide 27 and is emitted from the second planar surface S2, which is the observer-side surface, due to the effect of the polarizing beam splitter film 28 and the output deflector 30 that constitute the light beam extractor. As a result, the exit pupil of the optical image projection system 11 is expanded in the x-direction, and image light is emitted from the projection area of the second planar surface S2 of the light guide 27. In FIG. 15, illustration of the optical illumination system 14 and the optical projection system 16 is simplified in the optical image projection system 11.

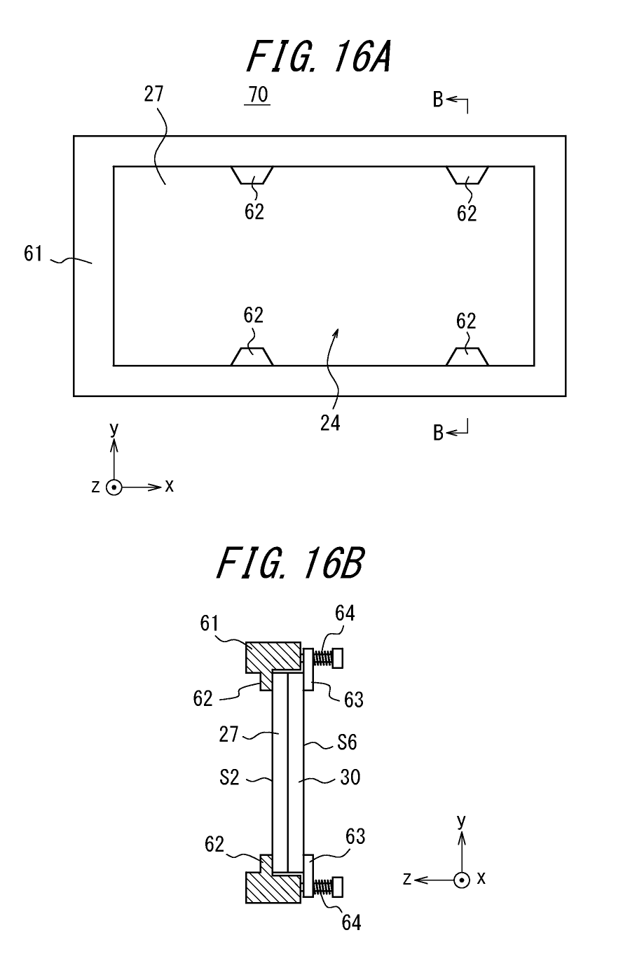

In this embodiment, the optical propagation system 24 is supported in the same way as the second optical propagation system 26 described in Embodiment 2. FIGS. 16A and 16B schematically illustrate the main structure of the support mechanism of the optical propagation system 24. FIG. 16A is a plan view from the z-direction, and FIG. 16B is a cross-section along the B-B line in FIG. 16A. The frame-shaped support member 61 restricts displacement of the optical propagation system 24 in the x-direction and the y-direction and supports the optical propagation system 24 to be displaceable in the z-direction. The support member 61 is fixed to the fixing portion of the display apparatus 70. A plurality of receiving portions 62 that project towards the inside of the frame are formed on the support member 61. The receiving portions 62 constitute a positioning member that positions the light guide 27 by abutting against the periphery of the second planar surface S2 of the light guide 27. The side of each receiving portion 62 that is contacted by the second planar surface S2 of the light guide 27 is formed as in FIG. 14A, FIG. 14B, or FIG. 14C.

Pressing members 63 that can each abut against the periphery of the triangular prism array surface S6 of the output deflector 30 are provided at the back surface side of the support member 61. The pressing members 63 are provided so as to be slidable in the z-direction and to be rotatable in the xy-plane for insertion into and removal from the open region in the frame of the support member 61. The pressing members 63 are pressed towards the receiving portions 62 by elastic members 64.

In a state of insertion into the frame of the support member 61, the optical propagation system 24 is pressed towards the receiving portions 62 by elastic members 64. As a result, the second planar surface S2 of the light guide 27 is elastically pressed into contact with the receiving portions 62 to position the optical propagation system 24.

According to this embodiment, the light guide 27 side of the receiving portions 62 is structured as illustrated in FIG. 14A, FIG. 14B, or FIG. 14C for point contact or line contact with the second planar surface S2. Hence, the contact area between the receiving portions 62 and the second planar surface S2 can be made extremely small as compared to the area of a human pupil. Accordingly, even if a portion of the image light is absent at the contact portion between the receiving portion 62 and the second planar surface S2, there is nearly no effect on the image quality of the observed image. Furthermore, by placing the receiving portions 62 in contact with the periphery of the light guide 27 to position the optical propagation system 24, an increase in size of the light guide 27 can be avoided.

Therefore, according to this embodiment, a display apparatus that allows observation of an image with good image quality without increasing the size and cost of the apparatus can be achieved.

### Embodiment 4

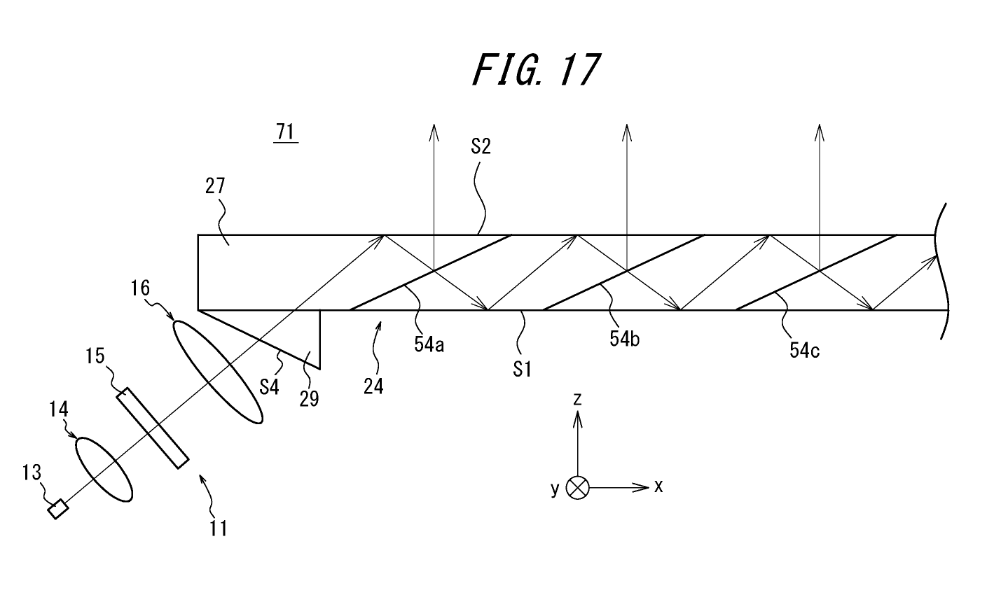

FIG. 17 schematically illustrates the main structure of a display apparatus according to Embodiment 4. A display apparatus 71 according to this embodiment has the structure of the display apparatus 70 of Embodiment 3, except that the light beam extractor of the optical propagation system 24 is configured differently. The differences from Embodiment 3 are described below.

Whereas the light extractor in Embodiment 3 is configured to include the polarizing beam splitter film 28 and the first output deflector 30, the light extractor in this embodiment is configured by providing a plurality of beam splitter films 54a, 54b, 54c, . . . along the x-direction in the light guide 27. The beam splitter films 54a, 54b, 54c, . . . are also collectively referred to below as beam splitter films 54. The beam splitter films 54 are formed at an inclination of 25° relative to the first planar surface S1 and the second planar surface S2 of the light guide 27.

In FIG. 17, image light that is incident on the second planar surface S2 in the light guide 27 from the inclined surface S4 of the input deflector 29 at an angle exceeding the critical angle is totally reflected at the second planar surface S2 and is incident on the beam splitter film 54a. A portion of the image light incident on the beam splitter film 54a is reflected, and the remainder is transmitted. The image light reflected at the beam splitter film 54a is emitted from the second planar surface S2. The image light transmitted by the beam splitter film 54a is totally reflected at the first planar surface S1, is then totally reflected at the second planar surface S2, and is incident on the beam splitter film 54b. Subsequently, while similarly being separated into transmitted light and reflected light at the sequential beam splitter films 54, the image light propagates through the light guide 27 by the light transmitted at the beam splitter films 54 repeatedly undergoing total reflection at the first planar surface S1 and the second planar surface S2. The light reflected at the beam splitter films 54 is emitted from the second planar surface S2.

As illustrated in FIGS. 16A and 16B, the optical propagation system 24 illustrated in FIG. 17 is positioned and supported by being pressed by the elastic member 64 against the receiving portions 62 of the support member 61. Since the support mechanism of the optical propagation system 24 is the same as in Embodiment 3, a description thereof is omitted.

Hence, in this embodiment as well, a display apparatus that allows observation of an image with good image quality without increasing the size and cost of the apparatus can be achieved, as in Embodiment 3.

This disclosure is not limited to the above embodiments, and a variety of changes and modifications may be made. For example, in Embodiment 3 and Embodiment 4, in order to reduce the apparatus in size, the optical image projection system 11 may be provided with any layout. For example, in FIGS. 15 and 17, the light source 13, optical illumination system 14, transmissive chart 15, and optical projection system 16 may be disposed in the direction of extension of the optical propagation system 24, i.e. in the x-direction, below the output deflector 30, and image light emitted from the optical projection system 16 may be suitably reflected by a reflecting member so as to be incident on the inclined surface S4 of the input deflector 29. In each of the above-described embodiments, the optical image projection system 11 may be configured to cause image light to be incident on the pupil enlarging optical system 12 by, for example, using a scan mirror to perform a raster scan with a light beam from a laser light source. In Embodiments 1 to 3, the light extractor may be configured to use a grating instead of a triangular prism array.

1. A display apparatus comprising:
a light guide;
an optical system configured to introduce image light into the light guide;
a light beam extractor configured to emit the image light propagating in the light guide from a surface of the light guide along an extent of propagation of the image light; and
a positioning member configured to position the light guide or a portion of the optical system by being in contact with the surface of the light guide.

2. The display apparatus of claim 1, wherein the positioning member is in contact with the surface of the light guide by being pressed elastically against the surface of the light guide.

3. The display apparatus of claim 1, wherein the positioning member is in point contact with the surface of the light guide.

4. The display apparatus of claim 2, wherein the positioning member is in point contact with the surface of the light guide.

5. The display apparatus of claim 1, wherein the positioning member is in line contact with the surface of the light guide.

6. The display apparatus of claim 2, wherein the positioning member is in line contact with the surface of the light guide.

7. The display apparatus of claim 3, wherein a surface of the positioning member in contact with the surface of the light guide is a rough surface.

8. The display apparatus of claim 4, wherein a surface of the positioning member in contact with the surface of the light guide is a rough surface.

9. The display apparatus of claim 7, wherein the rough surface has a surface roughness Rv of 0.6 μm or greater.

10. The display apparatus of claim 8, wherein the rough surface has a surface roughness Rv of 0.6 μm or greater.

11. The display apparatus of claim 1, wherein the positioning member is made of metal.

12. The display apparatus of claim 2, wherein the positioning member is made of metal.

13. The display apparatus of claim 3, wherein the positioning member is made of metal.

14. The display apparatus of claim 5, wherein the positioning member is made of metal.

15. The display apparatus of claim 7, wherein the positioning member is made of metal.

16. The display apparatus of claim 1, wherein the positioning member is made of plastic.

17. The display apparatus of claim 2, wherein the positioning member is made of plastic.

18. The display apparatus of claim 3, wherein the positioning member is made of plastic.

19. The display apparatus of claim 5, wherein the positioning member is made of plastic.

20. The display apparatus of claim 7, wherein the positioning member is made of plastic.
